(19) United States
(12) Patent Application Publication
(10) Pub. No.: US 2006/0067656 A1
(43) Pub. Date: Mar. 30, 2006

(54) Micromechanically manufactured infrared transmitter

(75) Inventors: Gerhard Mueller, Grafing (DE); Olaf Schulz, Muenchen (DE); Simon Ahlers, Groebenzell (DE); Jan Spanhake, Muenchen (DE); Martin Lloyd, Reading (GB)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/234,145

(22) Filed: Sep. 26, 2005

(30) Foreign Application Priority Data
Sep. 24, 2004 (DE) 10 2004 046 705.6

(51) Int. Cl. H05B 1/00

(52) U.S. Cl. 392/407

(57) ABSTRACT

A micromechanical infrared radiator has a radiator surface supported in a carrier chip. The radiator surface can be heated by a heating device. As a function of a temperature measurement, the heating power can be controlled such that the radiator surface assumes a defined temperature. For direct temperature measurement, a micromechanical temperature sensor in the form of a metal resistance is integrated in the radiator surface.

### BACKGROUND AND SUMMARY OF THE INVENTION

This application claims the priority of German patent document DE 10 2004 046 705.6, filed Sep. 24, 2004, the disclosure of which is expressly incorporated by reference herein.

The invention relates to a micromechanically produced infrared radiator having a radiator surface held in a carrier chip, which radiator surface can be heated by a heating device. The heating power is controllable as a function of a temperature measurement, such that the radiator surface assumes a defined temperature.

Such infrared radiators are used, for example, in gas sensors, in which it is important that the infrared radiator emits a precisely defined radiation on the radiator surface. The radiator surface represents practically a black radiator, and the emitted radiation depends on its temperature. This temperature is, in turn, affected by environmental influences, such as ambient temperature, the relative humidity of the surrounding atmosphere and the flow rate in the surrounding atmosphere.

The heating power supplied by the heating device is removed by solid-state heat conduction, heat conduction in the ambient air, convection and thermal radiation. In a state of equilibrium, a temperature of the radiator surface occurs at which the supplied and removed power are identical.

Solid-state heat conduction depends on the temperature difference between the radiator surface and the carrier chip and, thus, on the ambient temperature. Heat conduction via the ambient air, on the other hand, depends on the mean molecular mass in the air cushion between the hot radiator surface and the surrounding colder surfaces. The mean molecular mass decreases as the relative air humidity increases, because of the lighter water molecule.

It is known to supply a constant heating power to a radiator surface by means of the heating device, such as a heating resistor. The temperature of the radiator surface will then fluctuate, however, in response to the above-mentioned environmental influences.

It is also known to control the resistance of the heating resistor to a constant value. Moreover, the heating resistance depends on the temperature in a known manner, so that when the heating resistance is controlled to a given constant value, a constant temperature will also occur which is assigned to this value. However, in the case of known radiators of the present type, highly-doped semiconductors (whose temperature dependence of the resistance is very low and difficult to reproduce) are used for the heating resistance.

Accordingly, one object of the invention is to ensure, in a simple manner, a defined constant radiation output of the radiator surface in the case of a micromechanically produced infrared radiator of the type described above.

This and other objects and advantages are achieved according to the invention by integrating a micromechanically produced temperature sensor (in the form of a metal resistance) into the radiator surface, for direct temperature measurement.

As a result, a direct and simple temperature measurement takes place. By means of a metal resistance (for example, made of platinum), a sufficiently extensive, linear change of the resistance value with the temperature is obtained. The obtained characteristic is invariable and can easily be reproduced. In this manner, the temperature (and, therefore, also the radiation of the radiator surface) can be controlled precisely, by changing the heating power as the correcting variable. It was found that such a metal resistance can be integrated into the radiator surface.

Advantageously, the temperature sensor is a straight resistance strip which extends transversely over the radiator surface. The radiator surface, in turn, may be supported by an opening of the frame-shaped carrier chip, by supporting members that are characterized by low heat conduction. In this case, the resistance strip forming the temperature sensor extends with its two ends over the carrier chip and has electric contacts there.

According to a feature of the invention, the radiator surface is advantageously constructed as an integral semiconductor component, including the heating device, the carrier chip and the holding devices. The temperature sensor may be made of a high-temperature-stable material from the platinum, chromium or nickel group.

Furthermore, according to another feature of the invention, reference resistances can be integrated with the carrier chip, permitting regular check of the temperature sensor and of the heating resistance, by which aging (change of resistance, change of emissivity) can be detected.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic top view of an infrared radiator according to the invention; and

FIG. 2 is a schematic longitudinal sectional view along Line II-II of FIG. 1.

### DETAILED DESCRIPTION OF THE DRAWINGS

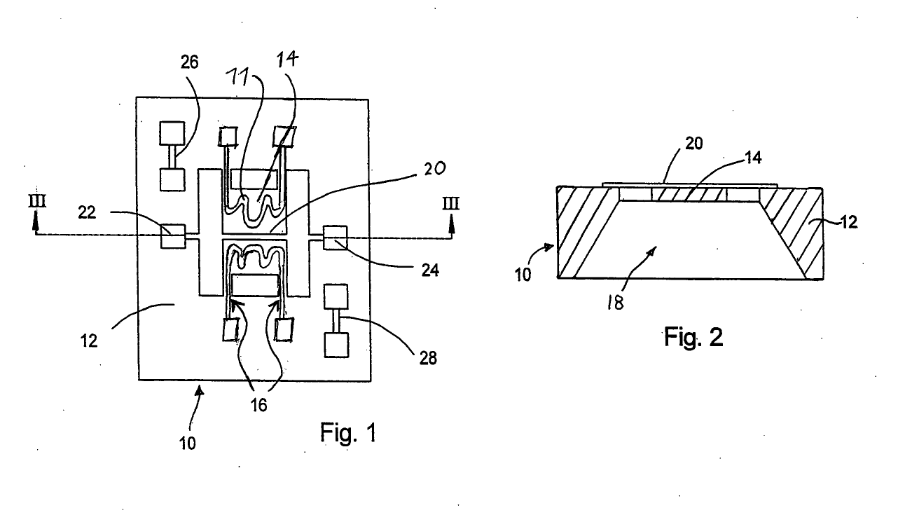

In FIGS. 1 and 2, reference number 10 indicates a carrier chip made of a semiconductor material. The carrier chip 10 forms a frame 12 and a radiator surface 14 (FIG. 2) which is heated by a heating device, such as a meander-shaped heating resistor. Supporting members 16, in the form of webs with a low heat conduction, support the radiator surface 14 in a central square opening 18 on the frame 12 of the carrier chip 10. The radiator surface is constructed as an integral semiconductor component with a heating device, the carrier chip and the supporting members.

In the illustrated embodiment, the carrier chip 10 is square in its top view, and forms the central square opening 18 (FIG. 2), in which the essentially square radiator surface 14 is centrally disposed. The webs of the supporting members 16 each extend as an extension of opposite edges of the radiator surface 14. As illustrated in FIG. 2, the frame 12 is significantly thicker than the radiator surface 14 with the heating device. The opening 18 expands toward the face of the carrier chip 10 facing away from the radiator surface 14.

On the face of the carrier chip 10 and the radiator surface 14 (at the top in FIG. 2), an also micromechanically produced temperature sensor in the form of a metal resistance 20 is integrated with the radiator surface 14 for direct measurement of the temperature. The temperature sensor is a straight resistance strip 20 which extends transversely over the radiator surface 14, with its two ends disposed over the carrier chip 10, and has electric contacts 22 and 24 there. In the preferred embodiment, the resistance strip 20 extends along a bisecting line of the carrier chip 10 and perpendicular to the webs of the holding devices 16, as shown in FIG. 1.

Furthermore, reference resistances 26 and 28 are integrated with the carrier chip 10 on the face of the carrier chip.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A micromechanical infrared radiator comprising:
a carrier chip; and
a radiator surface formed in said carrier chip, which radiator surface is heatable by a heating device, with a heating power that is controllable as a function of a temperature measurement, such that the radiator surface assumes a defined temperature;
wherein, for the direct temperature measurement, a micromechanical temperature sensor in the form of a metal resistance is integrated with the radiator surface.

2. The infrared radiator according to claim 1, wherein the temperature sensor is a straight resistance strip which extends transversely over the radiator surface.

3. The infrared radiator according to claim 2, wherein:
the radiator surface is held by supporting members having a low heat conduction, in an opening of the frame-shaped carrier chip; and
the resistance strip forming the temperature sensor extends across the carrier chip and has electric contacts at its extremities.

4. The infrared radiator according to claim 3, wherein the radiator surface is constructed as an integral semiconductor component with the heating device, the carrier chip and the supporting members.

5. The infrared radiator according to claim 4, wherein the temperature sensor comprises a high-temperature-stable material from one of the platinum, chromium and nickel groups.

6. The infrared radiator according to claim 5, wherein reference resistances are integrated with the carrier chip.

7. An micromechanical infrared radiator, comprising:
a carrier chip having a centrally situated opening therein;
a radiator surface formed integrally with said carrier chip and supported in said opening by integrally formed supporting webs; and
a micromechanical temperature sensor in the form of an elongated linear metal resistance which extends transversely across a surface of said carrier chip and is integrated with the radiator surface.

8. The infrared radiator according to claim 7, wherein the temperature sensor comprises a high-temperature-stable material from one of the platinum, chromium and nickel groups.

9. The infrared radiator according to claim 7, wherein reference resistances are integrated with the carrier chip.
